(19) United States
(12) Patent Application Publication
(10) Pub. No.: US 2004/0128475 A1
(43) Pub. Date: Jul. 1, 2004

(54) Widely accessible processor register file and method for use

(76) Inventor: Gad Sheaffer, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/331,608

(22) Filed: Dec. 31, 2002

(51) Int. Cl. G06F 15/00

(52) U.S. Cl. 712/32

(57) ABSTRACT

A processor includes one or more register files, one of the register files including wide connectivity to the execution units. The register file may include a small number of ports, where at least one of the ports is connected to multiple execution units. A method of use is presented.

### FIELD OF THE INVENTION

The invention relates to computer systems, and in particular, to registers within processors.

### BACKGROUND OF THE INVENTION

Modern microprocessors implement a variety of techniques to increase the performance of instruction execution, including superscalar microarchitecture, pipelining, out-of-order, and speculative execution. For example, superscalar microprocessors are capable of processing multiple instructions within a common clock cycle. Pipelined microprocessors may divide the processing (from fetch to retirement) of an operation into separate pipe stages and overlap the pipe stage processing of subsequent instructions in an attempt to achieve single pipe stage throughput performance.

High speed registers may store data locally within a processor. A processor may include many different execution units, each requiring access to data in the registers. The registers may be formed into a register file with a number of ports, allowing for, typically, simultaneous access by multiple execution units. However, adding ports to a register file increases the area of a register file, along with the capacitance and power consumption. The time to access the register file typically increases more than linearly with the number of ports. In some wide issue processors, the port number is kept low by dividing the processor into clusters of execution units, each with its own group of register files.

However, in many applications, certain data contained within registers is shared across many or all execution units within a wide issue processor. In a wide-issue processing core, all execution units (e.g., 16 execution units, although other numbers of execution units may be used) may require access to the same datum register during the same clock cycle. For example, each processing unit may require access to a register containing the branch metric value in a 16-wide Viterbi metric computation inner loop, where the register containing the branch metric is the third input operand of the operation, connected for example to the third adder input in a compare select add operation. Each processing unit may require access to a register collecting the arithmetic condition codes from multiple single instruction multiple data (SIMD) operations executing in parallel. Another example may be global access to a register containing constants used by multiple execution units, such as filter constants. When used herein, access to a register or memory may include read access or write access.

In a conventional register system, having a large number of registers (e.g., 128 registers, although other numbers of registers may be used) a large number of ports are typically required, which may cause the above mentioned problems.

Therefore, there exists a need for a register file efficiently allowing multiple execution units within a processor global simultaneous access to the same registers, and for a processor containing such a register file.

### BRIEF DESCRIPTION OF THE DRAWINGS

Aspects of the present invention, may best be understood by reference to the following detailed description when read with the accompanied drawings in which:

FIG. 1 is a simplified block-diagram illustration of a system and a processor according to one embodiment of the present invention;

FIG. 2 illustrates, in block diagram form, a global register file in accordance with one embodiment of the present invention;

FIG. 3 illustrates, in block diagram form, the plan of the registers of the register file of FIG. 2, in accordance with one embodiment of the present invention;

FIG. 4 is a flowchart depicting a method according to one embodiment of the present invention; and

FIG. 5 is a flowchart depicting a method according to one embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and displays presented herein are not inherently related to any particular computer or other apparatus. The desired structure for a variety of these systems will appear from the description below. In addition, embodiments of the present invention are not described with reference to any particular programming language, machine code, etc. It will be appreciated that a variety of programming languages may be used to implement the teachings of the invention as described herein.

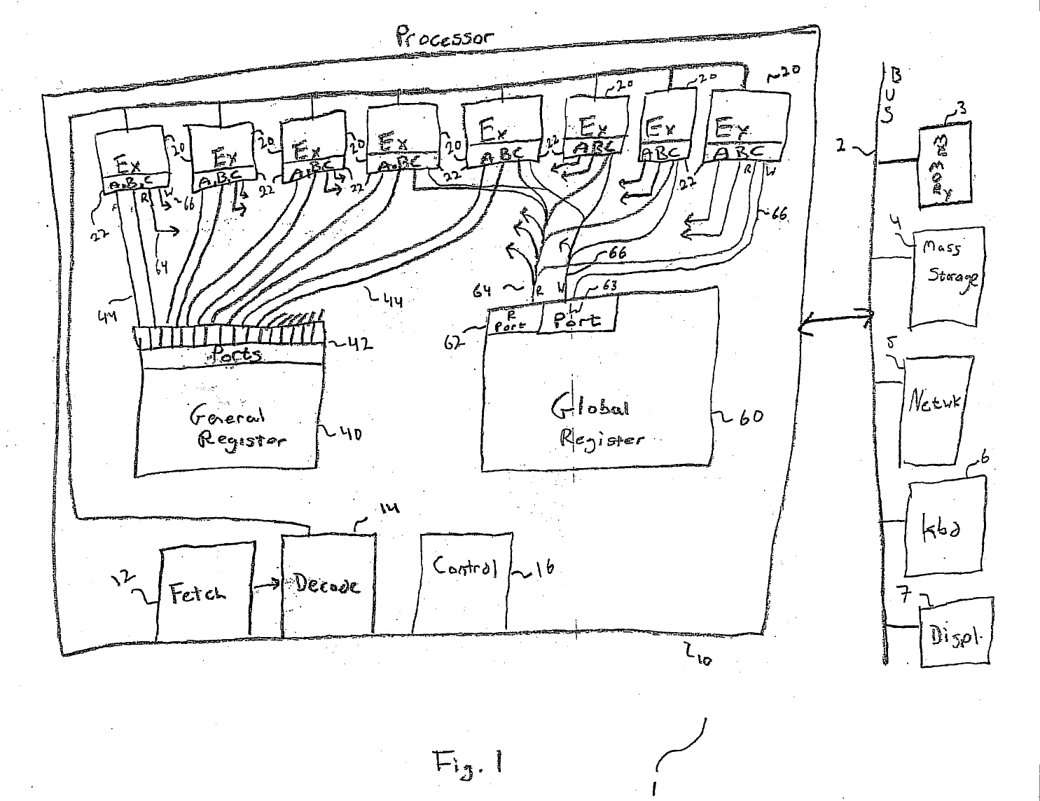

FIG. 1 is a simplified block-diagram illustration of a system and a processor according to one embodiment of the present invention. A wide issue, superscalar, pipelined microprocessor is shown, although the scope of the invention is not limited in this respect. Other processor types may be used. For example, a data processor used with an embodiment of the present invention may use a RISC (Reduced Instruction Set Computer) architecture, may use a Harvard architecture, may be a vector processor, may be a SIMD processor, may perform floating point arithmetic, may perform digital signal processing computations, etc. But for improvements related to an embodiment of the present invention, the example shown comprises components, a structure, and functionality similar to an Intel Pentium™ Processor, however, this is an example only and in no way is intended to limit the scope of the invention. Embodiments of the present invention may be used within or may include processors having varying structures and functionality. Note that not all connections and components within the processor or outside of the processor are shown, for clarity, and known components and features may be omitted, for clarity.

Referring to FIG. 1, processor 10 includes multiple execution units 20 (in the embodiment shown, eight execution units 20 are shown, but other numbers may be used). Each execution unit 20 is connected to a number of register file ports 22. In the example shown, each execution unit 20 includes three ports 22 labeled A, B and C. Ports 22 labeled A and B are typically used for general execution unit functioning. Ports 22 labeled C may be used for, for example, special operations requiring concurrent access to a register by multiple execution units 20. Other numbers of ports and other general purposes for ports may be used. Processor 10 includes a general register file 40, which may be a register file of known construction, and global register file 60. Processor 10 may include, for example, a fetch unit 12, a decode unit 14, and a control unit 16, of generally known construction, and may include other known units. Processor 10 may include other components and other combinations of components.

In the embodiment shown, the general register file 40 includes a set of ports 42, two ports 42 (in the case that each port 42 is a read/write port) for each execution unit 20, or 16 ports 42 total, and the global register file 60 includes a read port 62 (data being read from the register file 60) and a write port 63 (data being written to the register file 60). In one embodiment, each port 42 is either a read or write port, and thus, in the example shown, four ports 42 exist for each execution unit 20. Typically, each or certain of the execution units 20 are connected to the general register file 40 via busses 44, and to the global register 60 file via read busses 64 and write busses 66. For example, in FIG. 1, in each execution unit 20 ports 22 labeled A and B each connect to a separate port 42 on the general register file 40, and a third port 22 labeled C connects to the read port 62 and write port 63 of the global register file 60. Port 22 labeled C may be a read/write port or may include separate read/write ports. In FIG. 1, not all connections between execution units 20 and register files 40 and 60 are shown, for the sake of clarity. In alternate embodiments, a processor may include execution units not connected as shown to the general registers and global register file, and the processor may include other types of register files. For example, special purpose registers as is known in the art may be included. In alternate embodiments, the various register files may include other numbers of registers or ports, and the connections between the execution units and the register files may be different. For example, a global register file may include more than one port, and more than one port on one or more execution units may be connected to the global register file. Furthermore, other numbers of register files may be used; for example, an additional special purpose register may be used, more than one general register file may be used, etc.

In one embodiment, the global register file port(s) 62 and 63 of the global register file 60 are not connected to the “regular” execution unit ports 22 (e.g., ports A and B) but rather to ports 22 used for specialized functions (e.g., ports C), such as shuffle and polarity control, arithmetic flag outputs, or adder third inputs. In such cases, the global register file 60 replaces other register files only for a set of specific functions. However, a global register file need not be used only for performing specialized functions.

Typically, the global register file 60 is a wide issue register file (“WIRF”) which has a relatively small number of ports 62 and 63 (e.g., one, two, three) relative to the number of registers it contains, when compared to prior art processor register files. A system using an embodiment of the present invention may provide improvements by, inter alia, enabling a global register file to have faster response time, lower area, and/or better connectivity. Each of the small number of port(s) 62 and 63 is typically connected to a plurality (in the example shown, all) of the execution units 20.

In one embodiment, global register file 60 is a “squat” register file when compared with commonly used register files. In one embodiment, global register file 60 includes 8 registers (the global register file 60 may include other numbers of registers, such as 4, 16, or other numbers may be used), with typically a read port 62 and a write port 63 and a relatively large number of connections to execution units 20, such as eight (other numbers of ports and execution units may be used).

In an alternate embodiment, processor 10 may include multiple clusters of execution units 20, and each cluster may be associated with, for example, a cluster register file.

In one embodiment, processor 10, is included in a computer system 1 which includes, inter alia, a bus 2, a memory 3 (e.g., a RAM, ROM, or other components, or a combination of such components), a mass storage device 4 (e.g., a hard disk, or other components, or a combination of such components), a network connection 5, a keyboard 6, and a display 7. The memory 3 is typically external to or separate from the processor 10. However, the memory 3, or other components, may be located, for example, on the same chip as the processor 10. Other components or sets of components may be included. System 1 may be, for example, a personal computer or workstation. Alternately, the system may be constructed differently, and the processor need not be included within a computer system as shown, or within a computer system. For example, the processor may be included within a “computer on a chip” system, or the system holding the processor may be, for example, a controller for an appliance such as an audio or video system.

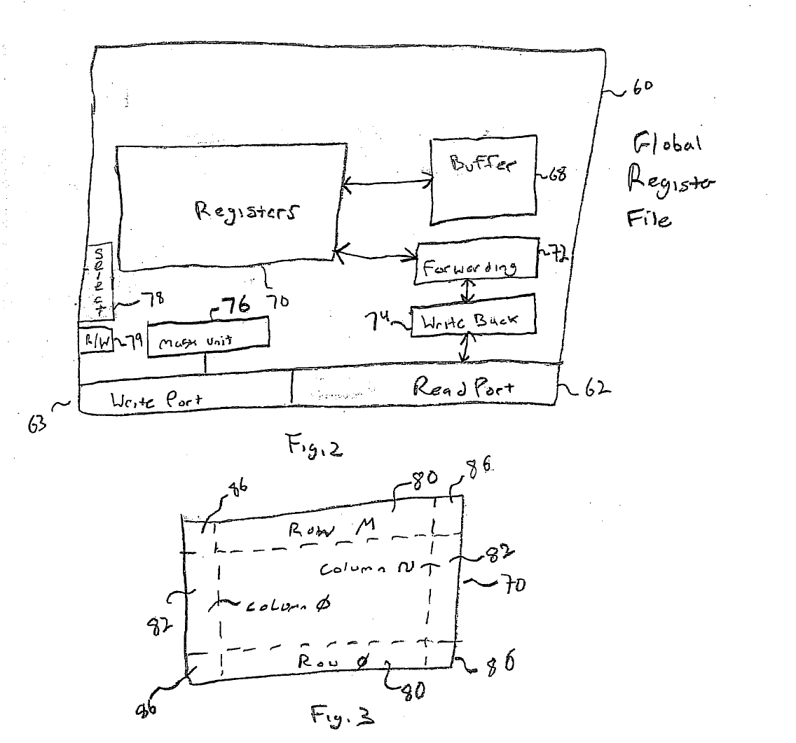

FIG. 2 illustrates, in block diagram form, a global register file 60 in accordance with one embodiment of the present invention. Referring to FIG. 2, global register file 60 may include known components, such as align unit (not shown), buffer 68, one or more registers 70, forwarding unit 72, write back buffer 74, and read port 62 and a write port 63 (multiple sets of ports may be used). An optional masked update unit 76 may be included to, for example, collect data from various sources (such as execution units 20) and combine the data into, for example, a single register 70. In an alternate embodiment, one port may be a read/write port. In the illustrated embodiment, each of registers 70 can hold 32 bits, and the ports 62 and 63 can transfer 32 bits, but other sizes are possible. Further, the port(s) 62 and 63 may have different sizes than the registers 70. Global register file 60 may connect to execution units 20 or other units via, for example, busses 64 and 66. Global register file 60 typically is used to store data.

Register selection data, such as which of a number of registers 70 are selected for an operation, may be input to register file 60 via, for example, select port 78, which may accept, for example, a set of bits which select or provide an “address” for a register. Registers may be selected from among a set in a different manner, and in some embodiments, only one register may be included. Whether or not a read or write application is to be performed may be input to register file 60 by, for example, read/write select input 79, which may accept, for example, one bit. Other methods of determining whether or not a read or write is to take place may be used. Register selection data may come from, for example, a field specifying the register number inside a decoded instruction. This field may be derived from the register number in the original instruction via the register alias table.

In operation, the relevant instruction determines which register 70 within the register file 60 is accessed, and wheather the access is a read or a write. In a read operation, the data corresponding to the register being referenced is placed on the port 62, and may be read by each execution unit 20 connected to the port. In some embodiments, not all of the execution units connected to the port 62 read data each time the global register file 60 is read from.

During a write operation to the global register file 60, each execution unit 20 writing to the global register file 60 may place data on the busses 66 and thus on port 63. For masked writes, where data from multiple write busses 66 may be combined, data from multiple write busses 66 drives the write port 63, and a control bit enables each execution unit 20 to update some of the bits of the register 70 being jointly updated by a plurality of execution units 20. The data from the multiple execution units 20 may thus be combined by the global register file 60 and transferred to one register 70 of the global register file 60. In one embodiment, such data transfer may be done simultaneously, each execution unit 20 writing at the same time to the write port 63. Such data transfer need not be performed simultaneously. Known masked update hardware (e.g., unit 76) may be included in a global register file 60 or may be connected to the global register file 60. For example, in a system where eight execution units write to a global register file with 32 bit wide registers, the global register file may take four bits from each execution register to write to the addressed register. Typically, for each execution unit 20, certain bits within the data unit sent from execution unit 20 are assigned to the same bit position within a register 70. Other methods may be used to collect data from multiple execution units. For example, multiple execution units may be assigned to the same bits in a register, combining the results, and each execution unit need not be assigned to the same position on each write.

FIG. 3 illustrates, in block diagram form, the plan of the registers of the register file of FIG. 2, in accordance with one embodiment of the present invention. Referring to FIG. 3, registers 70 include a matrix of rows and columns, n rows 80 and m columns 82 (for the sake of clarity, only two rows and two columns are shown), and n×m one bit memory cells 86 (for the sake of clarity, only four such cells 86 are shown). In one embodiment, n=4 and m=32, other suitable dimensions may be used. The cells 86 may be of known construction, including components such as transistors (e.g., MOSFETs or other suitable transistors), inverters, and/or other suitable components. The registers 70 may include other known components, such as read enable lines, write enable lines, read data lines, write data lines, and address decoders. In other embodiments, other structures may be used.

In operation, each execution unit 20 may, if and when needed, access one or both of a general register file 40 or the global register file 60. To read or write to or from the general register file 40 or the global register file 60, signals are sent via busses 44, 64 and 66, via known methods.

In one embodiment, the compiler, at compile time, determines which operands or data items should be stored in a global register file (e.g., the global register file 60 of FIG. 1), rather than a general or other register file. The compiler inserts a code or other indication in the executable code indicating that the operand or data item is to be stored in the global register file. In an alternate embodiment, the processor (e.g., the processor 10 of FIG. 1), at execution time, determines which operands or data items should be stored in a global register file, and stores the data appropriately. Indications that the data is more suitable for a global register file may be, for example, instructions in the instruction set which refer explicitly or implicitly to the global register file, that the compiler is processing certain instructions or instruction patterns, etc.

In one embodiment, if, at run time, it is determined that a datum should be placed in a global register file, the data is simply copied from the general register file to the global register file. Typically, the register alias table maps the register to the global register file; other methods of mapping may be done. There may be a pointer from the data item in the global register file to the general register file; this link may be stored or kept track of in a different manner. In the case that the data is not currently in a general register file, the data may be loaded from memory (e.g., memory 3 of FIG. 1) to either of the register files. If a context switch occurs, no state has been added to the processor 10, and the data may be copied from the global register file to the general register file (if the data has been changed), and then to memory, or directly to memory in place of the general register file copy. In such an embodiment, an additional register does not need to be saved during a context switch, as the global register file register is a shadow of the general register file register, unless modifications have occurred to the general register file register.

In a further embodiment, if it is determined that a datum should be placed in a global register file, the datum is moved from the general register file to the global register file, and the register that held the datum in the general register file can be reallocated. A machine state may be added. The global register file has no shadow in the general register file, and, during a state change, an additional register is saved/retrieved: if appropriate, both the general register file register and the global register file register may be saved.

In alternate embodiments, other methods of operating the various embodiments of the register system described herein may be used.

In use, a global register file according to one embodiment of the present invention may allow for global collection of the results of execution unit processing, and may enable multiple concurrently executing execution units to perform partial updates on the same register. For example, such an embodiment may enable concurrent execution of multiple SIMD instructions with sub-field non-overlapping predication. Such an embodiment may collect arithmetic or other flags from multiple instructions in the same register. Known masked update hardware or systems (e.g., masked update unit 76 of FIG. 2, or other systems) may be included in a global register file according to one embodiment, and all or multiple execution units may simultaneously send data to the register file, which collects the data and saves one or more bits from each execution unit 20 in the same register.

For example, the global register file may, typically, simultaneously accept a plurality of bits from each of the execution units. A subset (wherein “set” or “subset” may include only one item) of each plurality, according to, for example, a mask or predetermined pattern, is transferred to the appropriate position within the appropriate register within the global register file.

Other uses and methods of use are of course possible. For example, an operand or other data item may be quickly and efficiently distributed to all or a number of execution units. Such distribution (which may be effected via, for example, reads from the execution units 20 of FIG. 1) may be done simultaneously, from one port of the global register file.

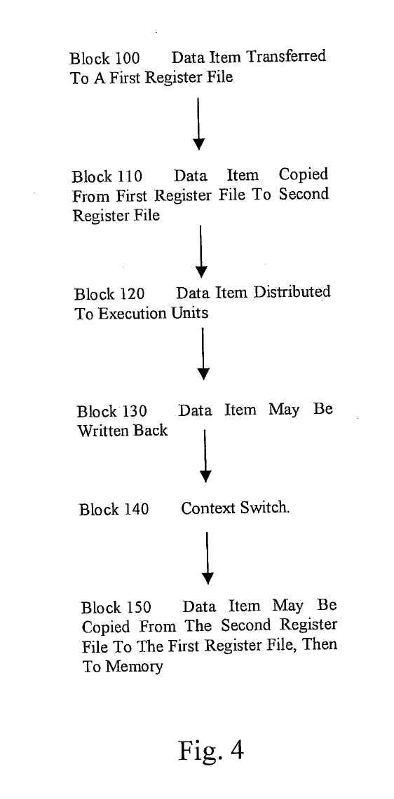

FIG. 4 is a flowchart depicting a method according to one embodiment of the present invention. The method depicted in the flowchart of FIG. 4 may be carried out using a device similar to that described with respect to any of FIGS. 1-3, or, alternately, another device having a suitable structure.

Referring to FIG. 4, at block 100, a data item, such as a word of a certain size (e.g., 32 bits, although other sizes may be used) is transferred from memory to a first register file, such as a general register file.

At block 110, the data item is copied from the first register file to a second register file, such as a global register file. This may be performed, for example, on the determination that the data item is more appropriate for the global register file. Typically, the data item is kept also in the first register file, and the register in the first register file holding the data item is not reallocated.

At block 120, the data item in the second register file may be, for example, distributed to execution units, and possibly modified. How the data item is processed, and whether it is modified, depends on, inter alia, the instruction, the state of the processor, etc. Such distribution may be to multiple execution units simultaneously. Such data transfer need not be performed simultaneously.

At block 130, if the data has been modified (or, in some embodiments, if the data has not been modified), the data item may be written back to the second register file by some execution units. In one embodiment, the modified data is collected from multiple execution units at one port of the second register file simultaneously. A mask, for example, may be used to collect the words of a certain width, combine words, and write the words to a register having the same width. Alternately, if the data is modified or used in another manner (by, for example, being added to another operand), the data may be written from the execution unit in another manner—for example, being written to another register file, or directly to memory.

At block 140, a context switch occurs.

At block 150, if appropriate (e.g., if the data item has been modified), the data item is copied from the second register file to the first register file, and copied from the first register file to memory.

In alternate embodiments, different steps or series of steps can be used. For example, data may be loaded directly from memory to a global register file, or may be loaded to the global register file in parallel with loading to the general register file. The data need not be modified (typically obviating the need for a write back), and data may be collected and written without an initial read. Other sets of register files may be used.

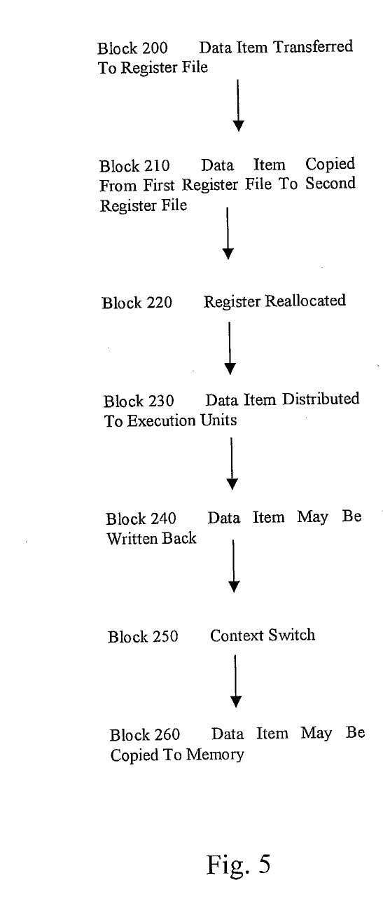

FIG. 5 is a flowchart depicting a method according to one embodiment of the present invention. The method depicted in the flowchart of FIG. 5 may be carried out using a device similar to that described with respect to any of FIGS. 1-3, or, alternately, another device having a suitable structure.

Referring to FIG. 5, at block 200, a data item, such as a word of a certain size is transferred from memory to a first register file, such as a general register file.

At block 210, data item is copied from the first register file to a second register file, such as a global register file.

At block 220, the register in the first register file holding the data item is reallocated. The data item in the first register file may be written over, as the register may be used for another data item.

At block 230, the data item in the second register file may be, for example, distributed to execution units, and possibly modified.

At block 240, if the data has been modified (or, in some embodiments, if the data has not been modified), the data item may be written back to the second register file by some execution units.

At block 250, a context switch occurs.

At block 260, if appropriate (e.g., if the relevant data items have been modified), the data item is copied from the second register file to memory,

In alternate embodiments, the order and/or identify of operations represented by the blocks of FIGS. 4 and 5 can be modified to accomplish the same results.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A processor comprising:
a plurality execution units; and
a register file, the register file including at least one register file read port and at least one register file write port, wherein each of the register file read port and register file write port is connected to two or more of the execution units, wherein each of the two or more of the execution units have simultaneous access to the at least one register file read port and at least one register file write port.

2. The processor of claim 1, comprising:
a second register file, the second register file including a plurality of second register file read ports and a plurality of second register file write ports, each second register file port connected to no more than one execution unit.

3. The processor of claim 1, wherein the register file includes a set of register file registers.

4. The processor of claim 1, wherein the number of register file ports is less than the number of execution units.

5. The processor of claim 1, wherein the register file includes a masked update unit.

6. The processor of claim 1, wherein the masked update unit is capable of collecting data from a set of the plurality of execution units, combining the data, and transferring the combined data to one register within the register file.

7. A computer system including:
a memory; and
the processor of claim 1.

8. A method of transferring data in a processor including a first register file, a second register file and a plurality of execution units, the processor being connected to a memory external to the processor, the method comprising:
copying a data item from the first register file to the second register file; and
in the event of a context switch, copying the data item from the second register file to the first register file, and copying the data item from the first register file to memory.

9. The method of claim 8, wherein the second register file includes at least one second register file port, wherein the at least one second register file port is connected to each execution unit.

10. The method of claim 8, comprising distributing the data item to the execution units from the second register file.

11. The method of claim 8, comprising simultaneously distributing the data item to the execution units from the second register file.

12. The method of claim 8, comprising collecting modifications to the data item at the second register file.

13. The method of claim 8, wherein the second register file includes a port, comprising collecting modifications to the data item at the second register file by simultaneously accepting data from each execution unit to the port.

14. The method of claim 8, comprising creating a pointer from the data item in the second register file to the first register file.

15. A method of transferring data in a processor including a first register file, a second register file and a plurality of execution units, the method comprising:
copying a data item from a first register in the first register file to a second register in the second register file;
reallocating the first register; and
providing simultaneous access by the execution units to the second register.

16. The method of claim 15 comprising, in the event of a context switch, copying the data item from the second register to memory.

17. The method of claim 15, wherein the second register file includes at least one second register file port, wherein the at least one second register file port is connected to each execution unit.

18. The method of claim 15, comprising distributing the data item to the execution units from the second register file.

19. The method of claim 15, comprising collecting modifications to the data item at the second register file.

20. The method of claim 15, wherein the second register file includes a port, comprising collecting modifications to the data item at the second register file by simultaneously accepting data from each execution unit to the port.

21. A method of transferring data in a processor including a first register file, a second register file and a plurality of execution units, the method comprising:
allowing each execution unit access to a register in the first register file simultaneously.

22. The method of claim 21, wherein the access is a read.

23. The method of claim 21, wherein the access is a write.

24. The method of claim 21, comprising:
simultaneously accepting, from each of the execution units, a plurality of bits; and
transferring, for each plurality of bits received, a set of the plurality of bits to the register.

25. The method of claim 24, comprising applying a mask to each plurality of bits.
